(19) United States
(12) Patent Application Publication
(10) Pub. No.: US 2016/0313560 A1
(43) Pub. Date: Oct. 27, 2016

(54) IMAGE PROJECTION DEVICE AND HEAD MOUNTED DISPLAY

(71) Applicant: HITACHI-LG DATA STORAGE, INC., Tokyo (JP)

(72) Inventors: Tomoto KAWAMURA, Tokyo (JP); Satoshi OUCHI, Tokyo (JP); Yoshiho SEO, Tokyo (JP); Toshiteru NAKAMURA, Tokyo (JP); Hidenao SAITO, Tokyo (JP); Kenji KIYA, Tokyo (JP); Yoshio OKAMOTO, Tokyo (JP)

(73) Assignee: HITACHI-LG DATA STORAGE, INC., Tokyo (JP)

(21) Appl. No.: 15/103,921

(22) PCT Filed: Oct. 31, 2014
(86) PCT No.: PCT/JP2014/079017

§ 371 Date: Jun. 13, 2016

(30) Foreign Application Priority Data
Jan. 20, 2014 (JP) 2014-007433

(51) Int. Cl. G02B 27/01

(52) U.S. Cl. CPC G02B 27/0172; G02B 27/0176; G02B 27/0179; G02B 2027/0185; G02B 2027/0138

(57) ABSTRACT

A head mounted display uses an image projection device comprising: an image generation unit for generating an image; a projection unit for guiding the image generated by the image generation unit to an observer's eyes; and a support for linking the projection unit and the image generation unit. The projection unit has a lens function which makes it easiest to see an image generated by the projection unit at a distance (Lobj) within a range between 30 cm and 3 m. Thereby, the image projection device operates at high resolution, has reduced size and weight, and reduces energy consumption.

### TECHNICAL FIELD

The present invention relates to an image projection device projecting an image on observer' eyes and a head mounted display using the same.

### BACKGROUND ART

As a projection optical system having a see-through function, Patent Literature 1 or the like has been proposed.

### CITATION LIST

### Patent Literature

PTL 1: Japanese Patent Application Laid-Open No. 2006-3879

### SUMMARY OF INVENTION

### Technical Problem

A head mounted display serving as a next-generation wearable device is expected because network information on the Internet is always obtained from a part of a field of vision.

In order to always display an image on a part of a field of vision, a low power consumption and an increase in area of a field of vision except for the image are important. For example, Patent Literature 1 describes an ocular window through which light is emitted to user's eye and an ocular window holding unit which holds the ocular window. In the ocular window, the width of a projection section in a visual axis direction of the user is set to 4 mm which is equal to the pupil diameter, and in a member constituting the ocular window holding unit, the width of the projection section in the visual axis direction is set to 4 mm or less in a range of 10 mm or more to obtain a see-through function. Further, the patent Literature 1 describes contribution to high efficiency and power saving by using a total reflection optical element in which an optical axis is bent toward user's eye.

A person changes her/his focal points. For example, the person sees a distant place 10 m far away from her/his position when she/he ordinarily sees a landscape, the person sees a place 2 to 10 m away from her/his position when she/he is walking, the person looks at the other person at a distance of approximately 1 m when she/he talks with her/him, or the person holds her/his magazine or the like at a distance of approximately 50 cm when she/he reads it.

Observer's eyes cannot simultaneously focus on far and near places. More specifically, in a head mounted display, when the observer looks at a distant place, the image which she/he looks at is desirably far away from her/his position. In contrast to this, when the observer looks at a near place, the image which she/he looks at is desirably near her/his position.

According to Patent Literature 1, the head mounted display has a see-through function when a projection section has a size equal to a pupil diameter of an ocular window unit. At infinity, the display has the see-through function. However, when an observer looks at an object at a distance of less than 5 m, the object is partially out of view to lose the see-through function.

It is an object of the present invention to provide an image projection device and a head mounted display each of which has a see-through function at far and near places, can achieve a low power consumption and a large field of vision, and can visually check images and fields of vision at both far and near places.

### Solution to Problems

The object can be achieved by the invention described in the scope of claims as an example.

### Advantageous Effects of Invention

A head mounted display which can visually check images at both far and near places and has a low power consumption and a large field of vision can be achieved.

### BRIEF DESCRIPTION OF DRAWINGS

FIGS. 1A and 1B are schematic views showing an image projection device 1 according to a first embodiment.

FIGS. 2A and 2B are diagrams for explaining a see-through function.

FIG. 3 shows a calculation result for explaining the see-through function.

FIG. 4 is a diagram for explaining an appearance of an image.

FIG. 5 is a diagram for explaining a resolution.

FIG. 6 is a diagram for explaining a field of view.

FIGS. 7A and 7B are schematic views showing an image projection device 301 according to a second embodiment.

FIGS. 8A and 8B are schematic views showing an image projection device 351 according to a third embodiment.

FIGS. 9A and 9B are schematic views showing an image projection device 41 according to a fourth embodiment.

FIGS. 10A and 10B are schematic views showing an image projection device 51 according to a fifth embodiment.

FIGS. 11A and 11B are schematic views showing an image projection device 61 according to a sixth embodiment.

FIG. 12 is a schematic view for explaining a ghost preventing function according to the sixth embodiment.

FIG. 13 is a schematic view showing an image projection device 81 according to a seventh embodiment.

FIGS. 14A and 14B are schematic views showing an image projection device 91 according to an eighth embodiment.

FIG. 15 is a schematic view showing an image projection device 101 according to a ninth embodiment.

FIGS. 16A and 16B are schematic views showing an image projection device 111 according to a tenth embodiment.

FIGS. 17A and 17B are schematic views showing an image projection device 121 according to an eleventh embodiment.

FIG. 18 is an explanatory view showing a head mounted display 131 according to a twelfth embodiment.

FIG. 19 is a schematic view showing a system configuration of the head mounted display 131 according to the twelfth embodiment.

### DESCRIPTION OF EMBODIMENTS

Modes to execute the present invention will be described below with reference to embodiments shown in the drawings, and the present invention is not limited to the modes.

### First Embodiment

A first embodiment of the present invention will be described below with reference to the accompanying drawings.

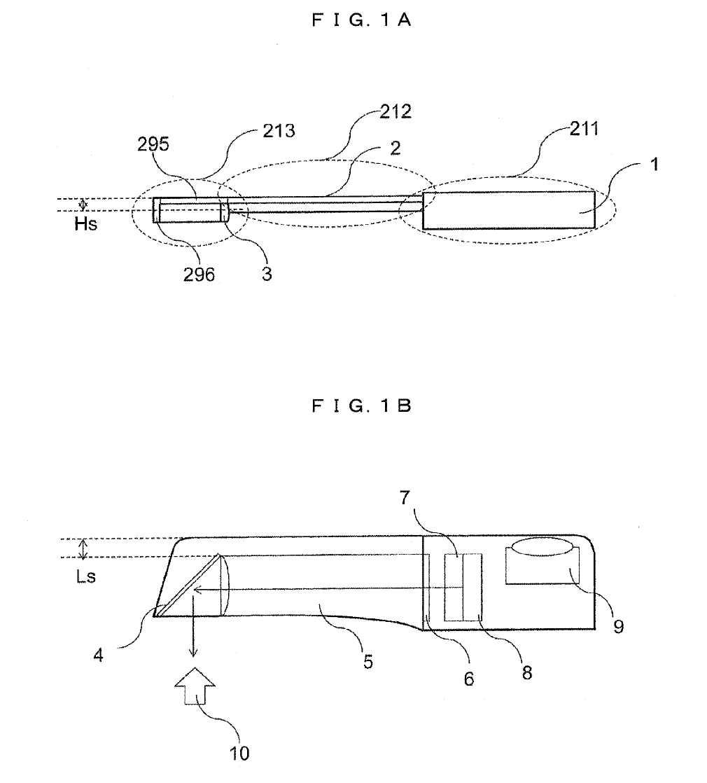

FIGS. 1A and 1B are schematic views showing an image projection device 1, in which FIG. 1A is a side view when viewing from observer's eye side and FIG. 1B is an upper view when viewing from above the eye. The upside of paper in FIG. 1A is a direction corresponding to the upside of the eye.

An image projection device 1 includes an image generation unit 211, a projection unit 213 guiding an image to observer's eyes, and a support unit 212 coupling the image generation unit 211 and the projection unit 213 to each other.

The image generation unit 211 includes an image generation element 7 generating an image. As the image generation element 7 mentioned here, a liquid-crystal element having red, blue, and green color filters for each pixel is supposed. Since the liquid-crystal element having the color filters is an ordinary device, the details of the element will not be described.

The image generation element 7 includes a light source 8. As the light source 8 mentioned here, a white backlight LED having a light-emitting surface larger than a region in which an image of the image generation element 7 is supposed. Since the white backlight LED is an ordinary device, the element will not be described.

The image generation unit 211 includes a protecting element 6 preventing dust, drops of water, and the like from being entered from the outside. The protecting element 6 is an optically transparent flat plate, and desirably forms an anti-reflection film in red to blue regions (range from wavelengths 430 nm to 670 nm) to reduce efficiency loss. The anti-reflection film is devised to inversely reflect light having a wavelength of 430 nm or less because the anti-reflection film is supposed to be used in the open air so as to make it possible to suppress the image generation unit 211 from internally deteriorated.

In the image generation unit 211, light emitted from the light source 8 passes through the image generation element 7 to generate an image, and the image is emitted by using the protecting element 9 as an emitting surface.

The image generation unit 211 includes an image-pickup element 9, and can also pick up an outside as an image. As the image pickup element 9, a compact camera is supposed.

The image picked up by the image pickup element 9 can be utilized such that a person is specified by, for example, a face scanning process or the like and information of the person is associated with the generated image.

An image generated by the image generation unit 211 is propagated to the projection unit 213 through air. The projection unit 213 includes a lens unit 3 and a total reflection surface 4. The lens unit 3 corresponds to an incidence unit receiving an image generated by the image generation unit 211. An arrow 10 illustrates a gaze direction.

The lens unit 3 is a so-called lens having a focal length F, and can make an image projected on observer's eyes virtual such that a distance between the image generation element 7 and the lens unit 3 is made shorter than the focal length F. A position Li of observer's eyes and the virtual image can be approximately calculated by the formula of an ordinary lens expressed by numerical expression 1 based on the focal length F of the lens unit 3 and an optical distance A between the image generation element 7 and the lens unit 3. A distance between observer's eyes and the virtual image has a negative sign because the corresponding image is virtual.

1/F=1/A+1/Li (Numerical Expression 1)

A mirror is generally supposed as the total reflection surface 4, and the total reflection surface 4 has a function of bending a traveling direction of an image traveling through the lens unit 3 to project the image to observer's eyes.

A projection unit 213 includes an upper wall 295 and a side-surface wall 296 and fixes the lens unit 3 and the total reflection unit 4 thereto. The lens unit 3, the total reflection unit 4, and the protecting element 6 are desirably hard-coated to prevent dust, drops of water, and finger marks from adhering to and being fixed thereto.

A support unit 212 is a mechanism coupling the image generation unit 211 and the projection unit 213, and is configured by a support mechanism 2 and a support mechanism 5 to avoid a region in which an image is propagated between the projection unit 213 and the image generation unit 211.

The support mechanism 2 is a mechanism supporting a side surface, and the support mechanism 5 is a mechanism coupling an incidence portion of the projection unit 213 and an upper side of an emitting portion of the image generation unit 211.

The support mechanism 2 has a width Hs smaller than that of the projection unit 213 when viewing from observer's eyes. This is to improve a see-through function (will be described later). The support unit 212 is preferably set such that a distance Ls in the eye gaze direction is larger than the Hs. The Ls is made larger than the Hs without simply narrow the width Hs to make it possible to secure necessary strength with, for example, a resin molded piece.

When the Ls is desired to be small in terms of design, for example, metal may be used, or a resin mold or the like into which metal is inserted may be used.

The support mechanism 5 is coupled to the support mechanism 2 to contribute to enhancement of its strength. When external light is incident on the image generation element 7, the incident light is reflected by the image generation element 7 and reflected on observer's eyes as unnecessary light. For this reason, the support mechanism 2 and the support mechanism 5 have a function of shielding light to prevent external light from being incident on the image generation element 7 and reflected on the observer's eyes as unnecessary light. The support unit 212 does not only simply couples the projection unit 213 and the image generation unit 211 to each other but also gives the light-shielding function, so as to advantageously secure confidence to prevent an image viewed by a user from being viewed by other persons.

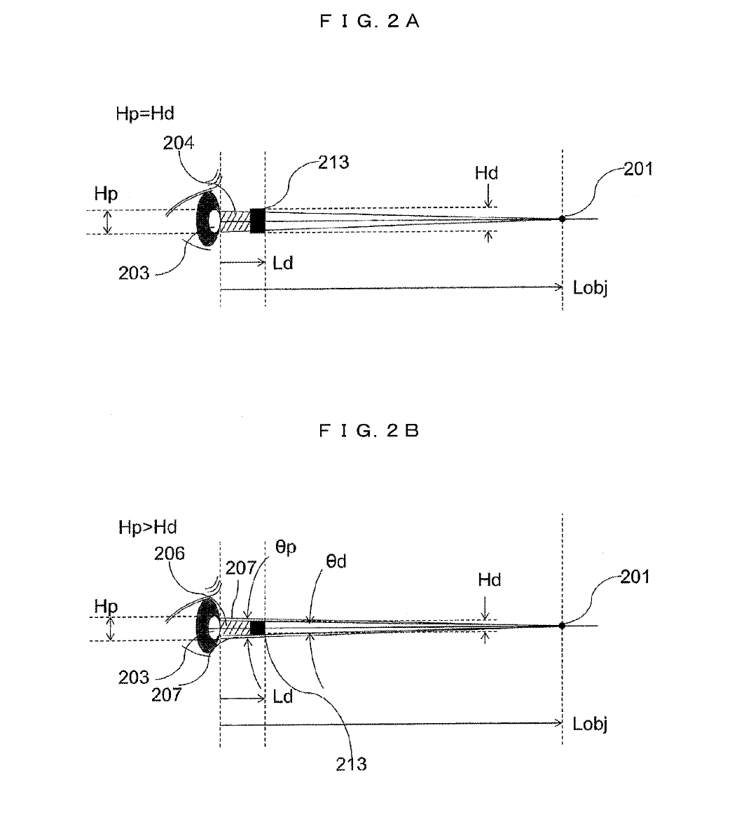

A see-through function will be described below with reference to FIG. 2.

FIGS. 2A and 2B illustrate an appearance of an object 201 placed at a distance Lobj when the projection unit 213 is disposed at a place at a distance Ld from a pupil 203 of observer's eyes.

FIG. 2A shows a case in which a width Hp of a pupil 203 is equal to the width Hd of the projection unit 213, and FIG. 2B shows a case in which the width Hd of the projection unit 213 is smaller than the width Hp of the pupil 203.

A beam emitted from a light source serving as an object is incident on observer's eyes, the person can recognize the object with her/his eyes.

When the width Hp and the width Hd are equal to each other, as shown in FIG. 1A, since the beam traveling from the object is completely shielded by the projection unit 213 (hatched region 204 in the drawing), the person cannot recognize the object. For this reason, the position of the object 201 must be dislocated, or the projection unit 213 must be dislocated.

In contrast to this, when the width Hd of the projection unit 213 is smaller than the width Hp, as shown in FIG. 1B, a beam traveling from the object is partially shielded by the projection unit 213 (hatched region 206 in the drawing). However, the beam (indicated by 207 in the drawing) is partially incident on a pupil 206. For this reason, the person can recognize the object. More specifically, an angle θd between the width Hd and the object 201 need only be smaller than an angle θp between the width Hp and the object 201.

This can be collected into numerical expression 2 based on a simple similarity relation.

Hp/Lobj>Hd/(Lobj−Ld) (Numerical Expression 2)

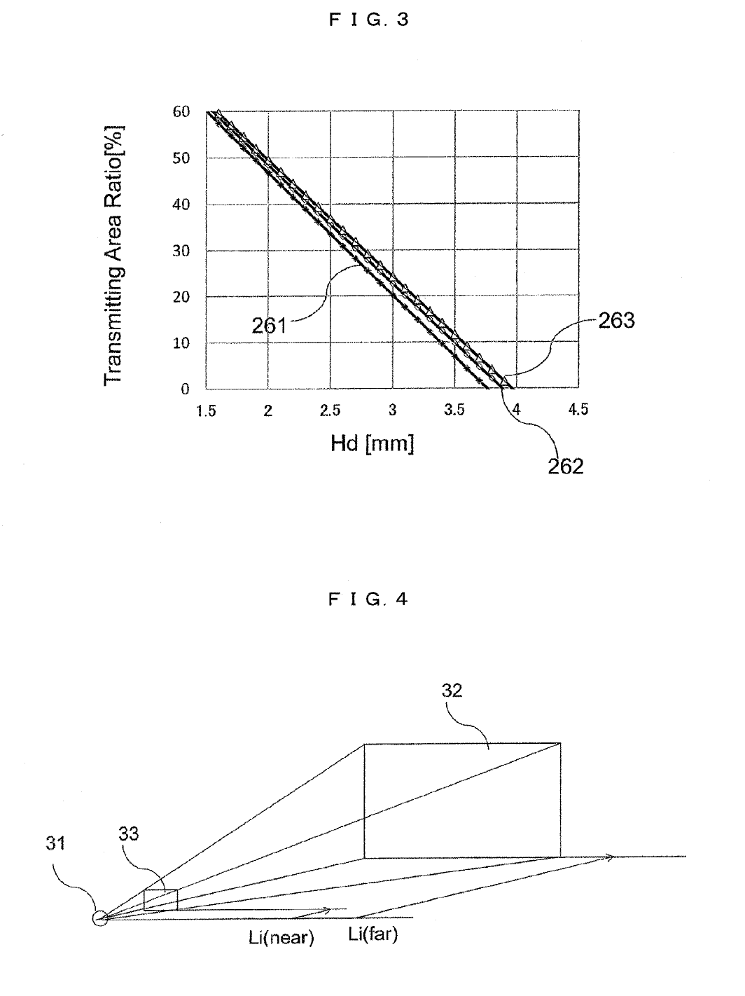

FIG. 3 is a graph obtained when the width Hp of the pupil is set to a general size of 4 mm, the distance Ld from the pupil of the projection unit 213 is fixed as 30 mm, and when the width Hd of the projection unit 213 changes, a transparent region ratio of a beam emitted from the object 201 and reaching the pupil without being shielded by the projection unit 213. The abscissa indicates the width Hd, and the ordinate indicates a ratio of a beam reaching the pupil. The ratio of the beam is expressed such that a transparent region ratio of a beam reaching the pupil without being shielded when the object 201 is defined as a point and a beam reaching the pupil in the absence of the projection unit 213 is used as a reference. A line 261, 262 and 263 which is a calculation result in the graph is drawn on the assumption that the distance Lobj from the pupil to the object is 50 cm, 100 cm, and 300 cm, respectively.

A person cannot accurately recognize a small object located at a distance of approximately 30 mm or less and having a size equal to that of her/his pupil. In addition, when the person wears glasses, the glasses are generally placed at a distance of 10 to 15 mm from her/his pupil. For this reason, a distance Ld between the projection unit 213 and the pupil is desirably set within the range of 15 mm to 30 mm or less such that even a person wearing glasses can dispose the projection unit 213. As an example, the distance Ld which is a condition under which a see-through function becomes most strict is set to 30 mm.

As is apparent from the calculation result, when the distance Lobj from the pupil to the object is 50 cm, the line 262 has a length of zero when the Hd exceeds 3.7 mm.

When the distance Lobj from the pupil to the object is 100 cm, a line 263 has a length of zero when the Hd exceeds 3.8 mm.

When the distance Lobj from the pupil to the object is 300 cm, a line 264 has a length of zero when the Hd exceeds 3.9 mm.

According to the graph, when the object is near the person, the transparent region ratio becomes small. It is true that, in order to make the near object visible, the equation 1 must be satisfied to cause a beam to be incident on the pupil.

When Ld=30 mm, Hp=4 mm, and Lobj=50 cm, a condition given by the width Hd of the projection unit 213<3.76 is a necessary condition. Thus, the width Hd of the projection unit 213 is desirably made smaller than 3.7 mm.

When the pupil diameter Hp and the width Hd of the projection unit 213 are set to be equal to each other, the equation 1 is not satisfied. Thus, an object located at a distance of 300 cm becomes invisible.

As a matter of course, the width Hs of the support unit 212 has the same relationship as described above. For this reason, the width Hs is desirably made smaller than the Hd, and, in the image projection device 1, an image is transmitted through air as described above to make it possible to make the support unit Hs smaller than the Hd. For example, it is true that, when the Hs is given as approximately 1.8 mm, even though the distance Lobj is 50 cm, the transparent region ratio becomes 50% to obtain a preferable see-through function.

FIG. 4 is a schematic view showing a relationship between a size and a position of an image projected from the projection unit 212 to observer's eyes and reflected as a virtual image.

The image projected on observer's eye 31 increases in size depending on the distance. For example, as shown in the drawing, a size of an image 33 at a distance of Li (near) and a size of an image 32 at a long distance Li (far) are in proportion to the distance Li.

More specifically, it is true that when the distance increases, the size of each pixel of the image also increases.

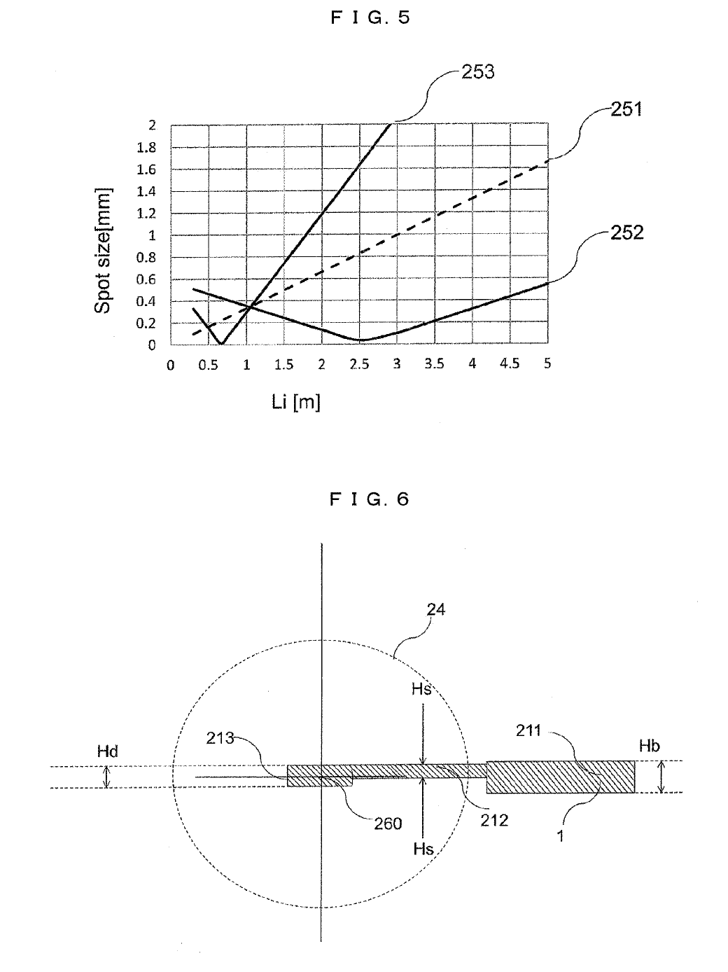

FIG. 5 shows a result obtained by calculating a relationship between the size of the pixel and a spot size of the pixel. The abscissa indicates the distance Li to the image, and the ordinate indicates the spot size. A broken line 251 indicates a spot size (1.5 pixels) which can be allowed to resolve the size of one pixel. A line 253 is obtained such that a focal position of each of the lens units 3 is set to minimize the spot size when the distance Li is 0.65 m, and a line 252 is obtained such that a focal position of each of the lens units 3 is set to minimize the spot size when the distance Li is 2.5 m. In this case, as an example, the relationship is calculated when a screen size located at a distance of 50 cm is 4 inches and a resolution is QVGA (360×240).

The beam has the minimum spot size at a predetermined focal position, and has large spot sizes before and after the focal position. Like the line 252, when the distance Li to the focal point is small, the spot size sharply increases after and before the focal point. In contrast to this, like the line 252, when the distance Li to the focal point is larger than the length of the line 252, an inclination of the spot size changing before and after the focal point becomes low. When the spot size is smaller than the broken line 251, an optical resolution can be obtained. For this reason, when it is assumed that a person works while viewing the object at an extremely short distance of 50 cm to 1 m and watching an image, the focal point must be close to her/him as indicated by the line 253. When it is assumed that the person works while viewing the object at a distance of 1 m or more and watching the image, the focal position must be far from her/him as indicated by the line 252.

As a matter of course, when the distance is 1 m, even a far image may be seen at a low resolution without making the focal point far from the person. In this case, as the head mounted display, a function of detecting a distance between a wearer and an object and changing an image into a low-resolution image is preferably given.

FIG. 6 is a schematic view illustrating a projection of the image projection device 1 when viewing from observer's eye. A crossing point of a cross is set as a center 260 of the observer's eye.

When the projection unit 213 is disposed at the center of the center 260 of observer's eye, the support unit 212 and the image generation unit 211 are projected as shown in the drawing. The width Hs of the support unit 212 and the width Hd of the projection unit 213 are set to satisfy the relationship expressed by numerical expression 2 as described above. In contrast to, the image generation unit 211 is very difficult to satisfy numerical expression 2 in consideration of mounting of the image generation element 7, the light source 8, and the mechanical mechanism. As an extreme example, when it is assumed that a person watches a 30-inch monitor (aspect ratio of 16:9) at a distance of 50 cm, a necessary angle of a field of vision is ±35°.

When the angle is larger than the given described above, a person may generally gaze the object while inclining her/his face. When the angle is considered as a reference, when a distance Ld=30 mm from observer's eye is set, it may be desired that a person checks an object without inclining her/his face in a range of the center of observer's eye to a position at a distance of approximately 21 mm (range indicated by a broken-line circle 24 in the drawing).

For this reason, as shown in FIG. 6, in the image projection device 1, the image generation unit 211 having the increasing width Hb is disposed out of the range of the center of observer's eye to a position at a distance of approximately 21 mm (out of the range indicated by a broken-line circle 24 in the drawing). When an image is transmitted through air, an optical distance becomes longer than that obtained when a transparent material having a refractive index.

In the image projection device 1 transmitting an image through air is devised to obtain a great advantage which can make the image generation unit 211 far from observer's eye.

As described above, in the image projection device 1 according to the first embodiment, a person can work while viewing an object located at an extremely short distance of approximately 50 cm and watching an image.

### Second Embodiment

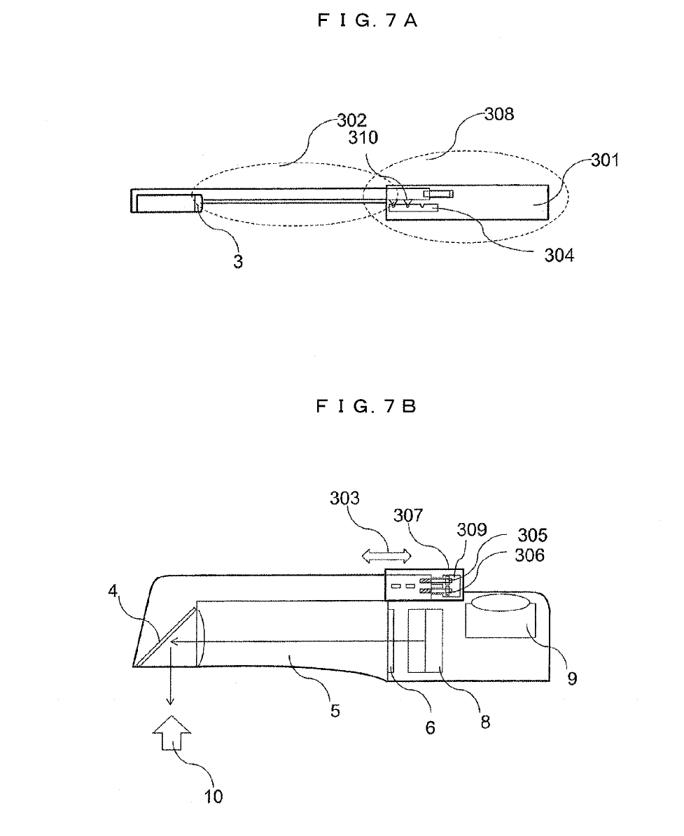

A second embodiment according to the present invention will be described below with reference to FIGS. 7A and 7B.

An image projection device 301 will be described below.

FIGS. 7A and 7B are schematic views showing the image projection device 301, in which, like FIGS. 1A and 1B, in which FIG. 7A is a side view when viewing from observer's eye side and FIG. 7B is an upper view when viewing from above observer's eye. The upside of paper in FIG. 7A is a direction corresponding to the upside of the eye.

The image projection device 301 is different from the image projection device 1 according to the first embodiment in that a focus mechanism is added. The same reference numerals as in the image projection device 1 denote the same parts in the image projection device 301. In this case, a support unit 302 and an image generation unit 308 including the focus mechanism which is not included in the image projection device 1 will be described below.

The focus mechanism uses the fact that, when a distance A between the lens unit 3 and the image generation element 7 changes, a distance Li of a virtual image changes according to numerical expression 1.

For this reason, at a position where an image generation unit 308 and the support unit 302 are coupled to each other, a mechanism 307 is disposed. Movement of the mechanism 307 in a direction of an arrow 303 allows a distance A to physically change.

In the mechanism 307, column supports 305 and 306 are fixed to the support unit 302, and the column supports 305 and 306 are fitted in a mechanism unit 309 of the image generation unit 308. In this case, the column supports 305 and 306 can be moved in a direction of the arrow 303. The image generation unit 308 includes a stopper 304, and the support unit 302 has a fitting portion 310 of the stopper to move the support columns 305 and 306 at only predetermined intervals.

This, as shown in FIG. 5, gives two regions including a region extending from a position at a distance of 50 cm to a position at a distance of 1 m and a region extending from a position at a distance 1 m or more. When such two focal points are given, an image and an object can be recognized in a region extending from a position at an extremely short distance of 50 cm to a position at a long distance of 5 m or more.

In the embodiment, in order to change a distance A, the lens unit 3 is explained as a moving mechanism. However, as a matter of course, a mechanism moving the image generation element 7 may be used.

### Third Embodiment

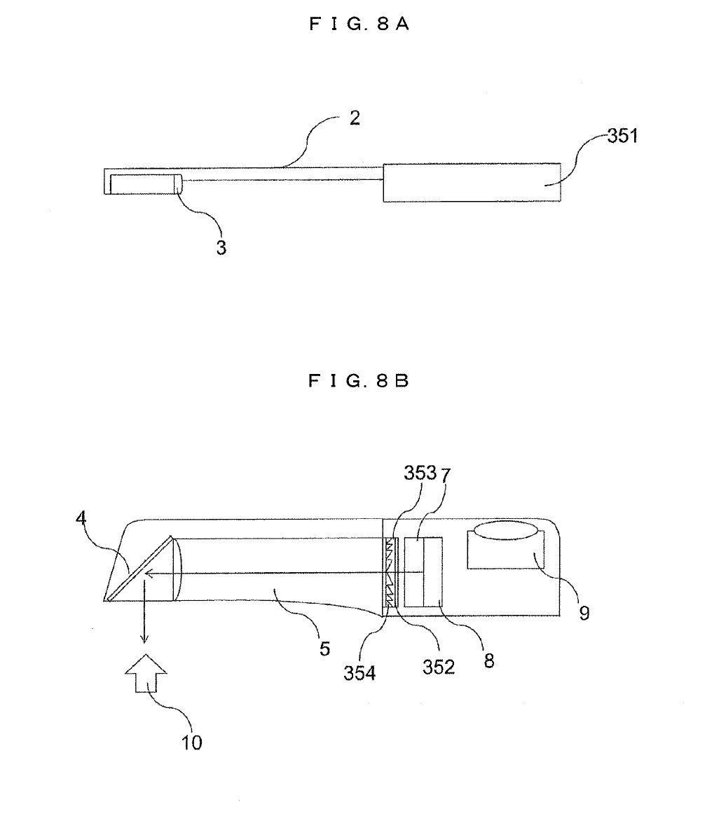

A third embodiment of the present invention will be described below with reference to FIG. 8.

An image projection device 351 will be described below.

FIGS. 8A and 8B are schematic views showing the image projection device 351, in which, like FIGS. 1A and 1B, in which FIG. 8A is a side view when viewing from observer's eye side and FIG. 8B is an upper view when viewing from above observer's eye. The upside of paper in FIG. 8A is a direction corresponding to the upside of the eye.

The image projection device 351 is different from the image projection device 1 according to the first embodiment in that a focus mechanism is added. The same reference numerals as in the image projection device 1 denote the same parts in the image projection device 351. In the image projection device 351, a liquid-crystal lens element 352 is disposed in place of the protecting element 6. The liquid-crystal lens element 352 having a focus function unlike in the image projection device 1 will be described below.

The liquid-crystal lens element 352 includes a liquid-crystal layer 352 and a Fresnel lens layer 354. The Fresnel lens layer 354 is equipped with a Fresnel lens. The liquid-crystal layer 353 is obtained such that a liquid crystal is sealed between a surface having a Fresnel lens shape and a surface adjacent thereto. When the liquid-crystal layer 353 is in an OFF state, since the liquid-crystal layer 353 and the Fresnel lens layer 354 have equal refractive indexes, the liquid-crystal layer 353 has the same function as that of a flat plate with respect to a beam. In an ON state, since the refractive index of the liquid-crystal layer 353 is different from that of the Fresnel lens layer 354, a beam is influenced by the Fresnel lens. In this manner, the power supply is turned ON/OFF to give the presence/absence of the lens function.

In order to give a focus function, there is a choice to change a focal length of the lens unit 3. For this reason, when the liquid-crystal lens element 352 is in an ON state, a combination lens between the lens unit 3 and the Fresnel lens gives a function of changing a focal length.

This, as shown in FIG. 5, also gives two regions including a region extending from a position at a distance of 50 cm to a position at a distance of 1 m and a region extending from a position at a distance 1 m or more. When such two focal points are given, an image and an object can be recognized in a region extending from a position at an extremely short distance of 50 cm to a position at a long distance of 5 m or more.

### Fourth Embodiment

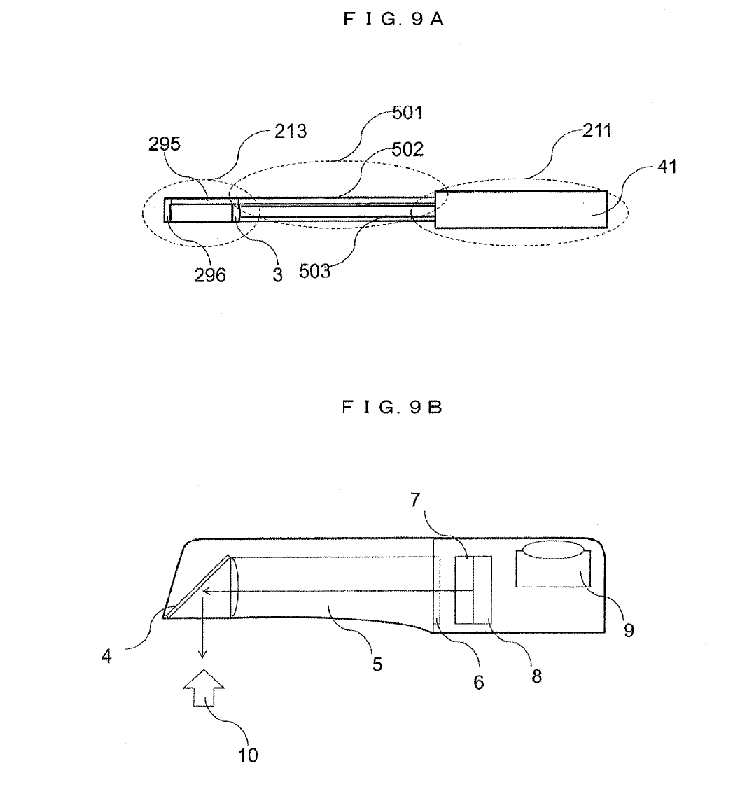

A fourth embodiment of the present invention will be described below with reference to FIGS. 9A and 9B.

An image projection device 41 will be described below.

FIGS. 9A and 9B are schematic views showing the image projection device 41, like FIGS. 1A and 1B, in which FIG. 9A is a side view when viewing from observer's eye side and FIG. 9B is an upper view when viewing from above observer's eye. The upside of paper in FIG. 9A is a direction corresponding to the upside of the eye.

In the image projection device 41, a support unit 501 has a configuration different from that in the image projection device 1 according to the first embodiment.

The support unit 501 includes support mechanisms 502 and 503. In the image projection device described above can cope with only one eye, i.e., a right eye or a left eye. As shown in FIGS. 9A and 9B, when the support mechanism 503 is disposed in addition to the support mechanism 502, the device can be vertically symmetrical approximately regardless of a left-to-right relationship.

When an additional value of the widths of the support mechanism 502 and the support mechanism 503 is made equal to or smaller than the width Hs of the support unit 212, the image projection device 41 can achieve the same see-through function as that of the image projection device 1.

### Fifth Embodiment

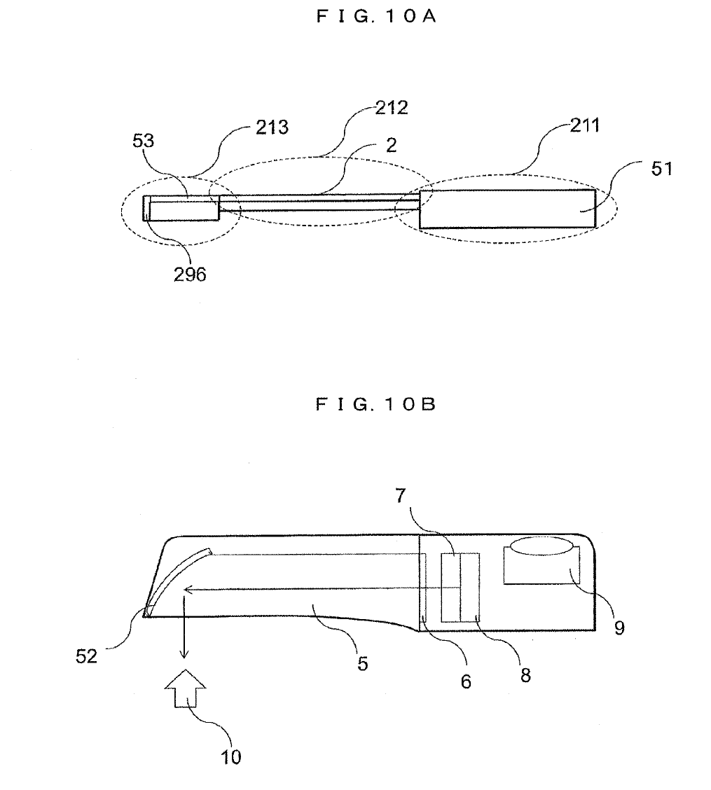

A fifth embodiment of the present invention will be described below with reference to FIG. 10.

An image projection device 51 will be described below.

FIGS. 10A and 10B are schematic views showing the image projection device 51, like FIGS. 1A and 1B, in which FIG. 10A is a side view when viewing from observer's eye side and FIG. 10B is an upper view when viewing from above observer's eye. The upside of paper in FIG. 10A is a direction corresponding to the upside of the eye.

In the image projection device 51, a projection unit 53 is different from that in the image projection device 1 according to the first embodiment.

The projection unit 53 has a free reflection unit 52. The free reflection unit 52 gives both the functions of the lens unit 3 and the total reflection unit 4 of the image projection device 1 according to the first embodiment to one component and has two functions including a function of lens and a function of reflecting a beam and causing the beam to travel to observer's eye.

In the configuration of the image projection device 1 according to the first embodiment, the shape of the free reflection unit 52 is preferably determined such that a wave front of a beam emitted to observer's eye is almost matched with a wave front obtained as a result of ray tracing.

The shape can be achieved by an inexpensive resin molded piece having a beam-receiving surface coated with metal such as aluminum.

When the two components are combined into one component to obtain advantages in productivity and cost.

The free reflection unit 52 is molded as a part of a mechanism component and metal-coated with respect to only its surface to obtain advantages such as high productivity and a cost advantage.

### Sixth Embodiment

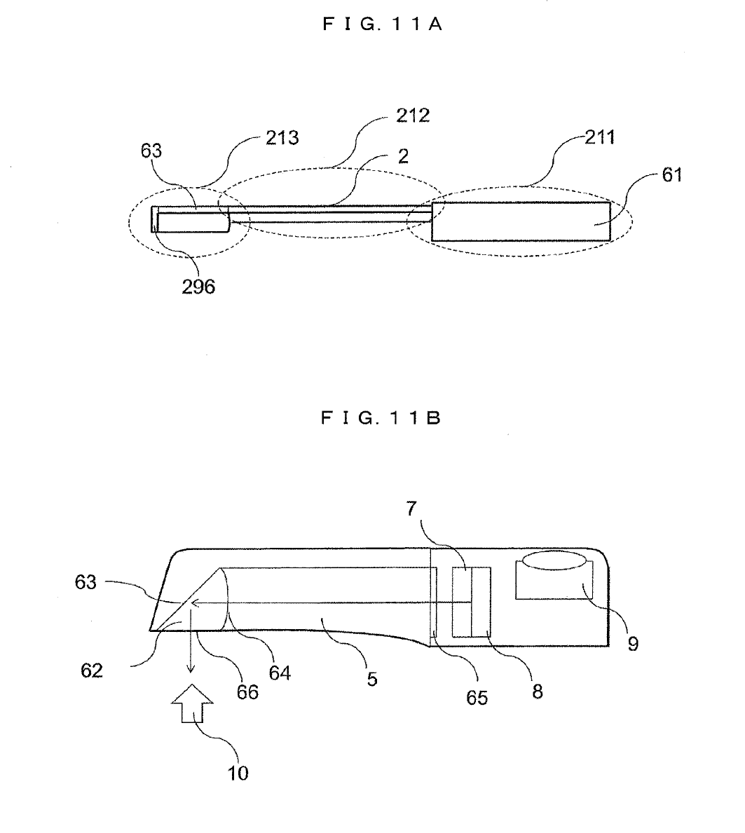

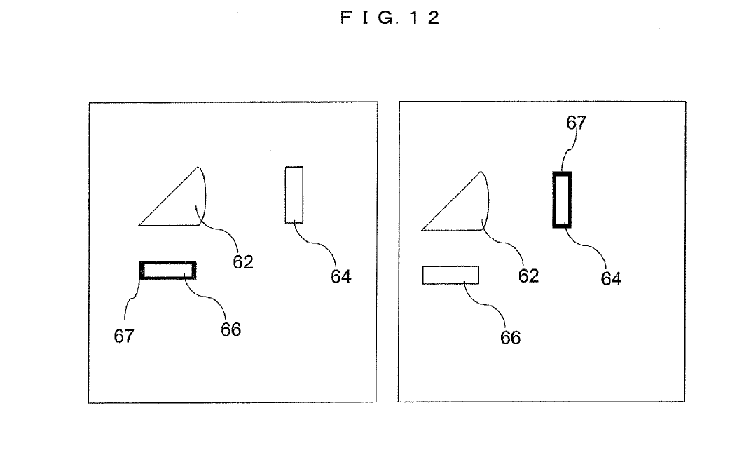

A sixth embodiment of the present invention will be described below with reference to FIGS. 11A and 11B.

An image projection device 61 will be described below.

FIGS. 11A and 11B are schematic views showing the image projection device 61, like FIGS. 1A and 1B, in which FIG. 11A is a side view when viewing from observer's eye side and FIG. 11B is an upper view when viewing from above observer's eye. The upside of paper in FIG. 11A is a direction corresponding to the upside of the eye.

The image projection device 61 is a modification of the image projection device 51 according to the fifth embodiment.

The projection unit 63 has a prism lens unit 62. The prism lens unit 62, like the free reflection unit 52, gives both the functions of the lens unit 3 and the total reflection unit 4 of the image projection device 1 to one component and has two functions including a function of lens and a function of reflecting a beam and causing the beam to travel to observer's eye.

The prism lens unit 62 has a total reflection surface 63 and a lens surface 64. A portion between the total reflection surface 63 and the lens surface 64 is made of a material having a refractive index. For example, the prism lens unit 62 is achieved such that the total reflection surface 63 and the lens surface 64 are resin-molded and the total reflection surface 63 is metal-coated.

As shown in the drawings, when an emitting surface 66 is a flat plane, a beam reflected by the surface returns to the image generation element 7 and travels to the observer's eye again so as to generate an optical path of stray light. For this reason, a stray light removing element 65 is mounted in place of the protecting element 6. The stray light removing element 65 is obtained by adding a ¼ wavelength plate function to a protecting element, and can be easily achieved by sticking a ¼ wavelength plate which is an inexpensive film to the protecting element 6.

As the image generation element 7, as described above, a liquid-crystal element is supposed. An ordinary liquid-crystal element includes a polarization film. In use of the ¼ wavelength plate, polarized light traveling from the image generation element 7 and polarized light returning to the image generation element 7 can be made orthogonal to each other. For this reason, stray light can be removed with a polarization film included in the image generation element 7.

When a configuration like the prism lens unit 62 is used, light reflected by the upper surface or the lower surface of the prism lens unit 62 to generate stray light. In order to prevent the stray light, as shown in FIG. 12, a light-shielding opening 67 is preferably formed around the emitting surface 66 or the lens surface 64 of the prism lens unit 62 to remove stray light.

As described above, in use of the prism lens unit 62, two components in the image projection device 1 are combined into one component to obtain advantages in productivity and cost.

### Seventh Embodiment

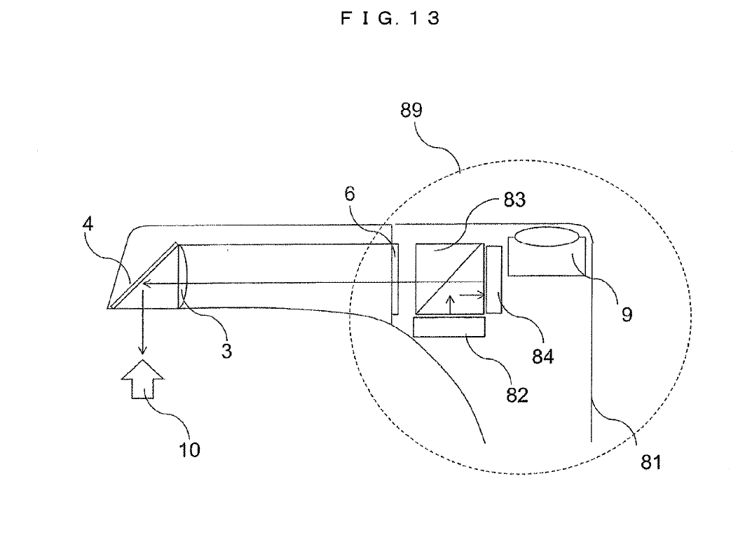

A seventh embodiment of the present invention will be described below with reference to FIG. 13.

An image projection device 81 will be described below.

FIG. 13 is a schematic view showing the image projection device 81. The drawing is an upper view when viewing from above observer's eye, and the upside of paper in FIG. 13 is a direction corresponding to the upside of the eye.

In the image projection device 81, the configuration of an image generation unit 89 is different from that in the image projection device 1 according to the first embodiment.

The image generation unit 89 includes a light source 82, a polarization beam splinter 83, and an image generation element 84. The light source 82 is a light source emitting lights of three colors, i.e., red, blue, and the light source 82 is achieved such that green, includes red, blue, and green LEDs are disposed and a diffusion plate is disposed on the surface of the light source. Only polarized light of light emitted from the light source 82 is reflected by the polarization beam splitter 83 and travels to the image generation element 84. Since the polarization beam splitter 83 is a conventional product, the polarization beam splitter 83 will not be described below.

As the image projection element 84, a reflection type liquid-crystal element free from color filter is supposed. The liquid-crystal element uses a conventional technique as an LCOS, and the details of the liquid-crystal element will not be described. Since the reflection type liquid-crystal element free from color filter can achieve pixels smaller than those of a liquid-crystal element with color filter, a high resolution can be achieved.

Of a beam, only a beam serving as an image is polarized and orthogonally transformed by the image generation element 84. For this reason, the image is incident on the polarization beam splitter 83 again. However, at this time, the image is reflected by the polarization beam splitter and directly travels.

The image traveling through the polarization beam splitter, as described above, is reflected on observer's eye through the protecting element 6, the lens unit 3, and the total reflection unit 4.

Coloring can be achieved by using a conventional light-emission control method of the light source 82 which is called a field sequential color.

As described above, the image projection device 81 can obtain an advantage, i.e., a high resolution by using a reflection type liquid-crystal element free from color filter as the image generation element 84.

### Eighth Embodiment

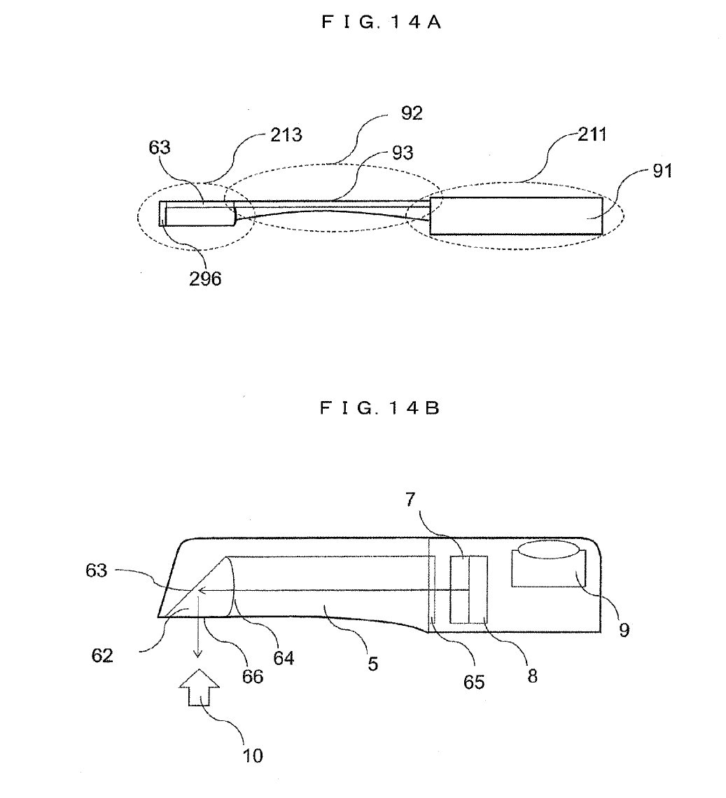

An eighth embodiment of the present invention will be described below with reference to FIGS. 14A and 14B.

An image projection device 91 will be described below.

FIGS. 14A and 14B are schematic views showing the image projection device 91, like FIGS. 1A and 1B, in which FIG. 14A is a side view when viewing from observer's eye side and FIG. 14B is an upper view when viewing from above observer's eye. The upside of paper in FIG. 11A is a direction corresponding to the upside of the eye.

The image projection device 91 is a modification of the image projection device 61 according to the sixth embodiment. The image projection device 91 is different from the image projection device 61 in the shape of a support unit 92.

The support unit 92 has a lower part which is not straight unlike a support mechanism 93 and which is curved. When the curved lower part is used, the strengths of the projection unit 213 on which stress is concentrated and the root of the image generation unit 211 can be advantageously improved.

### Ninth Embodiment

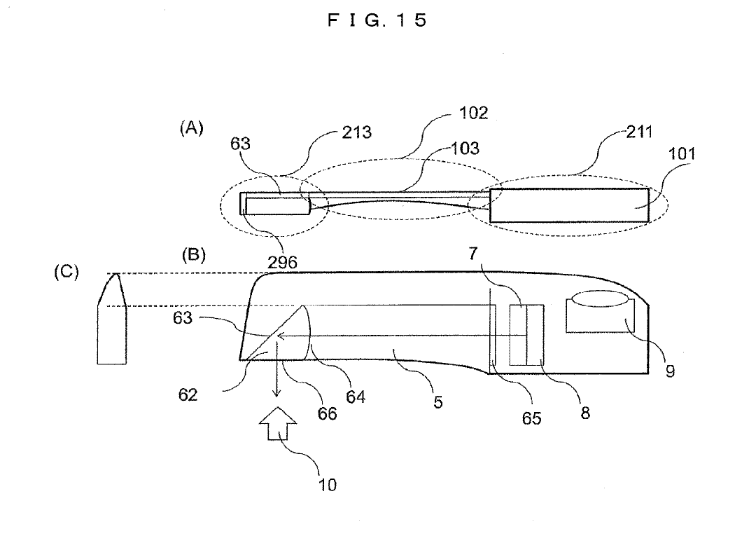

A ninth embodiment of the present invention will be described below with reference to FIG. 15.

An image projection device 101 will be described below.

FIGS. 15(A) to 15(C) are schematic views showing the image projection device 101, like FIGS. 1A and 1B, in which FIG. 15(A) is a side view when viewing from observer's eye side, FIG. 15(B) is an upper view when viewing from above observer's eye, and FIG. 15(C) is a view when viewing from the left side of paper in FIG. 15(B). The upside of paper in FIG. 15(A) is a direction corresponding to the upside of the eye.

The image projection device 101 is a modification of the image projection device 91 according to the eighth embodiment. The image projection device 101 is different from the image projection device 91 in the shape of a support unit 102.

The shape of the support unit 102 on a side far from observer's eye is not straight unlike a support mechanism 103 and is curved. When the support unit 102 is curved, the strength of the support unit can be more improved.

In this case, when the width of the support unit is reduced in a direction away from observer's eye as shown in FIG. 15(C), the strength of the support unit 102 can be improved without losing a see-through function.

### Tenth Embodiment

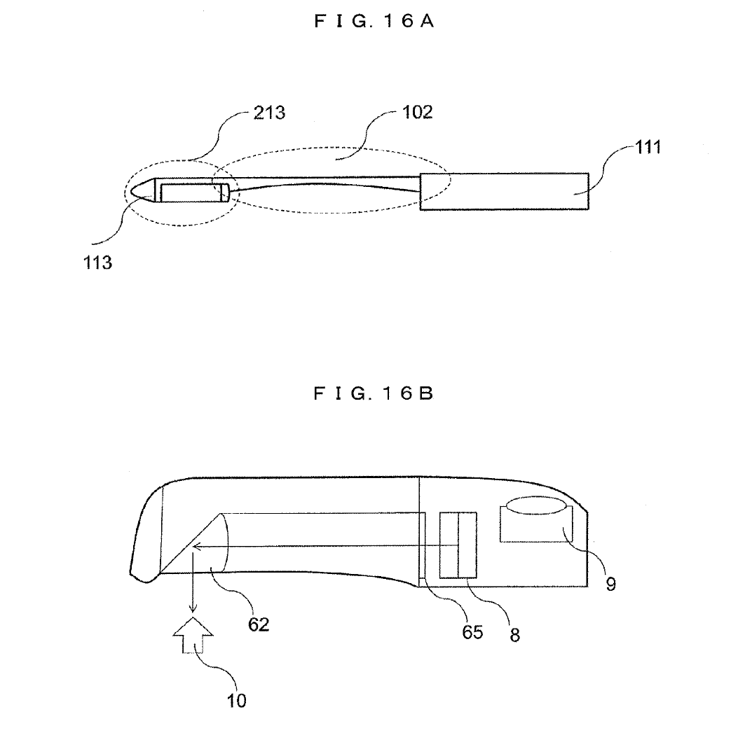

A tenth embodiment of the present invention will be described below with reference to FIG. 16.

An image projection device 111 will be described below.

FIGS. 16A and 16B are schematic views showing the image projection device 111, like FIGS. 1A and 1B, FIG. 16A is a side view when viewing from observer's eye side, FIG. 16B is an upper view when viewing from above observer's eye. The upside of paper in FIG. 16A is a direction corresponding to the upside of the eye.

The image projection device 111 is a modification of the image projection device 101 according to the ninth embodiment. The image projection device 111 is different from the image projection device 101 in the shape of the projection unit 213.

The projection unit 213 includes a protecting unit 113. The protecting unit 113 is disposed to prevent the projection unit 213 from sticking in observer's eye when a user slips and bumps into something, or the support unit 102 is broken by some chance. For this reason, the protecting unit 113 is desirably made of a flexible material such as rubber. As a matter of course, in order to prevent a see-through function from being deteriorated, the protecting unit 113 is desirably devised to have a narrow width.

### Eleventh Embodiment

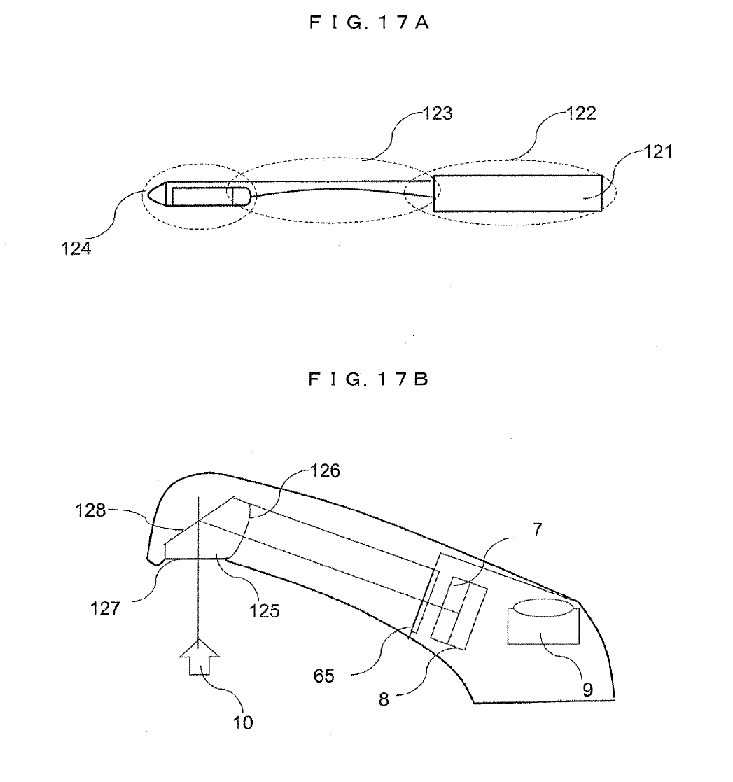

An eleventh embodiment of the present invention will be described below with reference to FIG. 17.

An image projection device 121 will be described below.

FIGS. 17A and 17B are schematic views showing the image projection device 121, like FIGS. 1A and 1B, FIG. 17A is a side view when viewing from observer's eye side, and FIG. 17B is an upper view when viewing from above observer's eye. The upside of paper in FIG. 17A is a direction corresponding to the upside of the eye.

The image projection device 121 is a modification of the image projection device 111 according to the tenth embodiment. In the image projection device 121, in comparison with the image projection device 111, a beam traveling path extending from an image generation unit 122 to a projection unit 124 bent.

For this reason, the shape of the prism lens unit 125 is devised. An emitting surface 127 is orthogonal to an arrow 10 which is an eye gaze direction like the emitting surface 66. A lens unit 126 is orthogonal to an image traveling direction. At this time, the angle of a total reflection unit 128 is adjusted such that a beam is orthogonal to the lens unit 126 and the emitting surface 127 to make it possible to achieve the configuration.

As described above, when the traveling path is bent, the image projection device 121 is formed along the shape of a head. Improvement in design can be obtained as an advantage. Furthermore, since the angle is adjusted to cause the image generation unit 122 to be close to a person, a wide field of view can also be advantageously secured.

When an angle between a direction of a beam from the image generation unit 122 to the projection unit 124 and the arrow 10 exceeds 45°, the image projection device 121 hits at the wearer. For this reason, the angle is preferably set within the range of 45° to 90°.

### Twelfth Embodiment

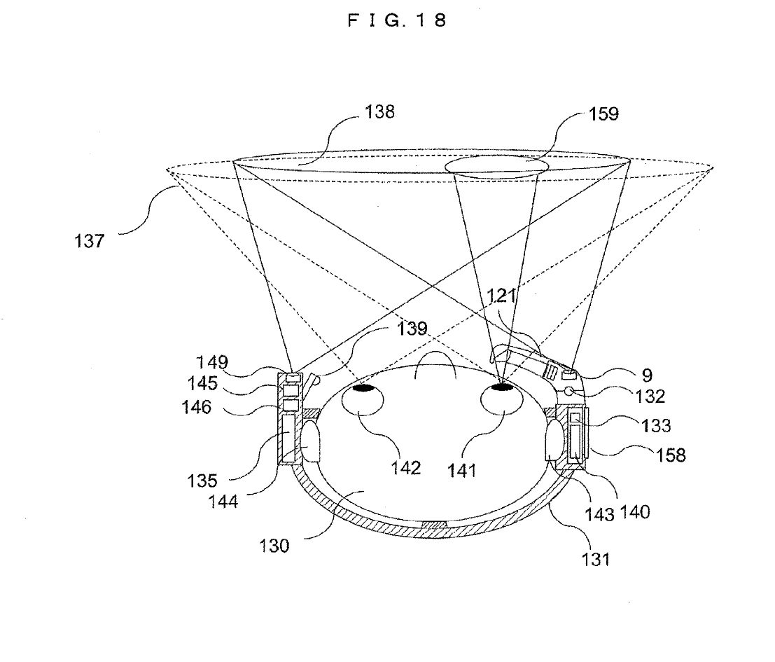

A twelfth embodiment of the present invention will be described below with reference to FIG. 18.

A head mounted display 131 will be described below.

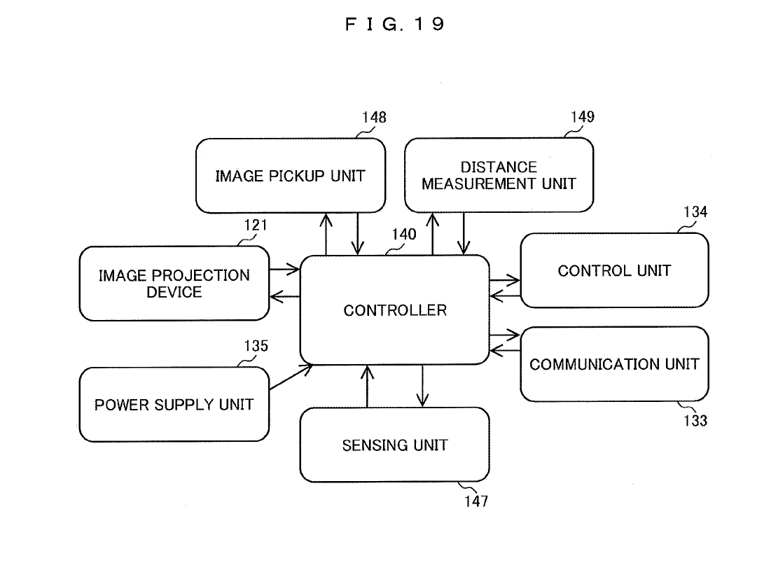

FIG. 18 shows a state in which a person wears the head mounted display 131, and FIG. 19 shows a system block of the head mounted display 131.

The head mounted display 131 includes the image projection device 121, image pickup means 148 such as image pickup elements 9 and 136, a power supply unit 135, a communication unit 133, a control unit 134 such as a voice sensing element 139 and a touch sensing element 158, a controller 140, sensing means 147 such as an acceleration sensing element 145 and a position sensing element 146, a distance measurement unit 149, and the like.

As the power supply unit 135, a rechargeable power supply like a battery is mainly supposed. As the communication unit, a communication device such as a Wi-Fi device or a Bluetooth (tradename) device which can access information on the Internet or an electronic device held by a wearer 130. The touch sensing element 158 is a sensing element such as a touch panel. The voice sensing element 139 is a device such as a microphone sensing words of a wearer. As the control unit 134, a processing means to operate the head mounted display 131 by the wearer 130 on the basis of voice recognition using the voice sensing element 139, finger position information using the touch sensing element, or the like is supposed. The acceleration sensing element 145 is an element which detects an acceleration by using a principle of a piezoelectric element, an electric capacitance, or the like. The position sensing element 146 is an element such as a GPS which can sense a position. As the distance measurement unit 149, a device which can measure a distance by using the Time-of-Flight principle is supposed. The controller 140 is a main chip controlling the devices and the means.

In the head mounted display 131, an image 159 formed by the image projection device 121 can be observed in a field of vision 137 of the wearer 130. The head mounted display 131 includes an angle adjustment mechanism 132 which can adjust an angle such that the image 159 can be observed in the field of vision 137. The wearer 130 can preferably adjust the position of the image 159. The angle adjustment mechanism 132 as described above can be easily achieved by, for example, a hinge or the like.

In FIG. 18, it is supposed that the image projection device 121 is loaded on a right eye 132. However, for example, when the image projection device 41 is used, the image projection device 41 can also be loaded on a left eye 142.

Since the image projection device 121 is shaped such that a traveling path of a beam from the image generation unit 122 to the projection unit 124 is bent, it can be confirmed that the image projection device 121 is formed along the shape of the head of the wearer 130.

Since the head mounted display 131 is used to be fixed to a head such that the head mounted display 131 is put on ears 143 and 144, temporal portions, back of the head, or the like, both the hands become free.

A method of using the image projection device 121 will be described below. For example, when a pathway has a small step when the wearer 130 is walking, the controller 140 processes an image signal acquired by the image pickup means 148, recognizes the presence of the step, and can inform the wearer of information such as “caution about step” on the image projection device 12. At this time, the controller 140 also has a function of causing the light source 8 to emit light and sending a predetermined image signal to the image generation element 7.

The power supply unit 135 supplies a necessary electric power to a necessary means or device through the controller 140. At this time, the controller 140 also has a function of supplying an electric power to the device as needed.

When social network information related to the wearer 130, for example, information representing that a train used in commute has been stopped by an accident is generated, the communication unit 133 transmits the information to the controller 140 to make it possible to inform the wearer of information representing “delay of the commuter train by accident” through the image projection device 121. At this time, the controller 140 has a function of always monitoring information on the Internet in response to requests from the wearer 130.

When the wearer 130 begins to read her/his newspaper or magazine, the distance measurement unit 149 transmits distance information of an object in front of the wearer 130 to the controller 140 and ON/OFF-controls the power supply to the liquid-crystal lens element 352 included in the image projection device 351 to make it possible to change the liquid-crystal lens element 352 to cause the liquid-crystal lens element to focus on a place near the object. At this time, the controller 140 has a function of capable of driving the liquid-crystal lens element 352 or the like included in the image projection device 351. The controller 140 also has a function of monitoring information of the distance measurement unit 149.

When the wearer wants to take a picture through the image pickup means 148, the controller 140 uses voice recognition using the voice sensing element 139 or detects a request from the wearer 130 from the control unit 134 such as position information of a finger obtained by using the touch sensing element to drive the image pickup means 148 to make it possible to take a picture. In this case, the information of the taken picture can be moved by using the communication unit 133 onto a cloud network held by wearer 130 on the Internet.

The controller 140 is desired to always preferentially process a signal from the control unit 134.

When the wearer 130 is sleeping in a train, the controller 140 can also perform power saving such as turning-OFF control of the image projection device 121 on the basis of pieces of information obtained from the acceleration sensing element 145 sensing swing of her/his head and the image pickup means 148 sensing being in the train.

When the wearer 130 is in a region different from a region she/he is always in, the controller 140 detects a state in which the place is different from the place she/he is always in to determine whether she/he takes a private trip or a business trip and obtains a guidance of the trip, food information about the place she/he is staying, or the like from the communication unit 133 to make it possible to inform the wearer of the pieces of information.

As described above, the controller 140 also has a function of determining contents to be processed on the basis of pieces of information.

The present invention is not limited to the embodiments described above, and includes various modifications. For example, the embodiments have been described in detail to understandably explain the present invention, and are not always limited to embodiments including all the configurations described above. Some of the configurations of a certain embodiment can be replaced with configurations of another embodiment, and, to the configurations of a certain embodiment, the configurations of another embodiment can also be added. With respect to some of the configurations of each of the embodiments, addition, deletion, and replacement of other configurations can be performed.

Some or all of the configurations, the functions, the processing units, the processing means, and the like described above may be achieved by hardware such that, for example, integrated circuits are designed. The configurations, the functions, and the like may be achieved by software such that a processor interprets and executes programs achieving these functions. Information such as programs, tables, and files achieving the functions can be stored in a recording device such as a memory, a hard disk device, or an SSD or a recording medium such as an IC card or an SD card.

Control lines and information lines which are required for the explanations are described, and all the control lines and the information lines are not always described in the product. Actually, almost all the configurations may be regarded to be connected to each other.

### REFERENCE SIGNS LIST

1 . . . image projection device
3 . . . lens unit
4 . . . total reflection surface
6 . . . protecting element
7 . . . image generation element
8 . . . light source
9 . . . image pickup element
130 . . . wearer
131 . . . head mounted display
133 . . . communication unit
134 . . . control unit
135 . . . power supply unit
139 . . . voice sensing element
140 . . . controller
145 . . . acceleration sensing element
146 . . . position sensing element
147 . . . sensing means
149 . . . distance measurement unit
158 . . . touch sensing element
211 . . . image generation unit
212 . . . support unit
213 . . . projection unit

1. An image projection device projecting an image on observer's eyes comprising:
an image generation unit generating an image;
a projection unit guiding the image generated by the image generation unit to observer's eye; and
a support unit coupling the projection unit and the image generation unit to each other, wherein
the image generation unit includes an emitting portion emitting a generated image,
the projection unit includes an incident portion receiving the image emitted from the image generation unit,
the projection unit has a lens function of making the image generated by the projection unit most visible at a distance in a range of 30 cm to 3 m, and
an image is transmitted through air between the emitting portion of the image generation unit and the incident portion of the projection unit.

2. (canceled)

3. The image projection device according to claim 1, wherein
the support unit has a width smaller than that of the projection unit.

4. The image projection device according to claim 3, wherein
the image generation unit is disposed out of a ±35° range when a person straightly looks forward from a pupil center of her/his eye.

5. The image projection device according to claim 3, wherein
the support unit includes a light-shielding wall which covers at least one surface formed by the image generation unit and the projection unit.

6. The image projection device according to claim 3, wherein
an angle formed by a line formed by connecting centers of the emitting portion of the image generation unit and the incident portion of the projection unit to each other and a line formed by a traveling direction of an image projected on observer's eye falls within a range of 45° to 90°.

7. The image projection device according to claim 3, wherein
the image generation unit includes an image generation element generating an image, and
the image projection device has a focus adjustment function of changing a distance of the image visually recognized with observer's eye by changing a distance between the projection unit and the image generation element.

8. A head mounted display projecting an image on a part of a field of vision, comprising:
the image projection device according to claim 1;
a power supply unit supplying an electric source;
an image pickup unit picking up an external image;
a communication unit communicating information with an outside;
a sensing unit detecting a position, an angle, an acceleration, and the like of a user;
a control unit allowing the user to control the head mounted display;
a distance measurement unit measuring a distance to an object in front of the user; and
a controller controlling an operation of the head mounted display, wherein
the head mounted display has a function of changing a resolution of an image depending on distance information obtained from the distance measurement unit.
